(19) United States
(12) Patent Application Publication
(10) Pub. No.: US 2014/0293404 A1
(43) Pub. Date: Oct. 2, 2014

(54) APPARATUS AND METHOD FOR GENERATING ULTRASHORT LASER PULSES

(71) Applicant: EOLITE SYSTEMS, Pessac (FR)

(72) Inventors: Simonette Pierrot, Dietikon (FR); Francois Salin, Gradigan (FR)

(73) Assignee: EOLITE SYSTEMS, Pessac (FR)

(21) Appl. No.: 14/230,993

(22) Filed: Mar. 31, 2014

Related U.S. Application Data
(60) Provisional application No. 61/833,293, filed on Jun. 10, 2013.
(60) Provisional application No. 61/807,608, filed on Apr. 2, 2013.

(51) Int. Cl. H01S 3/094

(52) U.S. Cl. CPC H01S 3/094076
USPC 359/341.3; 359/345

(57) ABSTRACT

An apparatus includes a pulse conditioner and an amplifier. The pulse conditioner configured modifies a temporal intensity profile of an input laser pulse, thereby creating a conditioned laser pulse having conditioned temporal intensity profile with a misfit parameter, M, of less than 0.13, where:

$${M}^{2} = \frac{\int {[ {\vert ψ \vert}^{2} - {\vert {ψ}_{Pfit} \vert}^{2} ]}^{2} d t}{\int {\vert ψ \vert}^{4} d t} ,$$

where |Ψ(t)|2 represents the pulse temporal intensity profile of the conditioned laser pulse and |ΨPfit(t)|2 represents a parabolic fit of the conditioned laser pulse. The amplifier increases the power of the conditioned laser pulse creating an amplified laser pulse. In a method a temporal intensity profile of an input laser pulse having a pulse duration of at least 1 ps is modified to create a conditioned laser pulse, which is amplified to create an amplified laser pulse, which is temporally compressed to generate a compressed laser pulse having a compressed pulse duration less than the input pulse duration.

### CROSS-REFERENCE TO OTHER APPLICATIONS

This application claims the benefit of U.S. provisional patent application Nos. 61/833,293, filed 10 Jun. 2013; and 61/807,608, filed 2 Apr. 2013, the disclosures of which are incorporated by reference.

### BACKGROUND

Embodiments of the present invention as exemplarily described herein relate generally to the generation of ultrashort laser pulses. More particularly, embodiments of the present invention relate to the generation of ultrashort laser pulses having a high peak power.

Ultrashort laser pulses (i.e., laser pulses having a FWHM pulse duration in a range from a few tens of picoseconds to one femtosecond) having a high peak power are desirable to implement material processing applications such as marking, engraving, micro-machining, cutting, drilling, etc. Typically, such laser pulses are produced by amplifying picosecond or femtosecond laser pulses that have been produced by a laser oscillator. However amplification of short and ultrashort pulses is strongly affected by non-linear effects such as self phase modulation (SPM) within the amplifier. With pulses having a usual Gaussian temporal intensity profile, although SPM induces strong spectral broadening that could be used for pulse compression from picosecond to femtosecond durations, the Gaussian modulation of the temporal phase cannot be perfectly compensated for by conventional means such as grating pair compressors. When a laser pulse experiences strong SPM during amplification and is temporally compressed using a pair of gratings, the temporal intensity profile of the compressed amplified laser pulse will typically have relatively large amount of energy lying in wings around the main pulse, which can make the pulse unsuitable for material processing applications.

It is known that the magnitude of the SPM induced within the amplifier is proportional to the intensity of the laser pulse travelling through the amplifier. Therefore, SPM has conventionally been controlled by ensuring that the laser pulses entering the amplifier have a relatively low intensity. One traditional method of reducing the laser pulse intensity involves increasing spatial beam size of the pulse using a large-diameter amplifier (e.g., via a disk laser). Another method, known as Chirped Pulse Amplification (CPA), involves temporally stretching an initial laser pulse produced by a laser oscillator to produce a stretched laser pulse (typically having a pulse duration more than 1000 times greater than the pulse duration of the initial laser pulse) that has a peak power lower than that of the initial laser pulse. Thereafter, the stretched pulse is amplified and then temporally compressed. CPA can be very effective if the initial laser pulse is produced by femtosecond laser oscillators, but becomes cumbersome and ineffective if the initial laser pulse has a pulse duration greater than 1 ps because of the very small spectral bandwidth of the pulse. In any case, the pulse duration of the compressed laser pulse is, at best, as short as the pulse duration of the initial laser pulse. SPM has also been used in pulse compression without amplification. Such techniques typically involve inducing strong SPM in a fiber and compensating for the resultant chirp using dispersive elements such as gratings, prisms, etc. The quality of the compressed laser pulses is generally not suitable for material processing applications.

Embodiments of the present invention exemplarily described herein below, address these and other limitations associated with the prior art.

### BRIEF SUMMARY

An example of an apparatus includes a pulse conditioner and an amplifier. The pulse conditioner is configured to modify a temporal intensity profile of an input laser pulse, thereby creating a conditioned laser pulse having conditioned temporal intensity profile characterized by a misfit parameter, M, of less than 0.13, where M is obtained by the following expression:

$${M}^{2} = \frac{\int {[ {\vert ψ \vert}^{2} - {\vert {ψ}_{Pfit} \vert}^{2} ]}^{2} d t}{\int {\vert ψ \vert}^{4} d t} ,$$

where |ψ(t)|² represents the pulse temporal intensity profile of the conditioned laser pulse and |ψ_{Pfit}(t)|² represents a parabolic fit of the conditioned laser pulse. The amplifier is coupled to an output of the pulse conditioner source and configured to increase the power of the conditioned laser pulse, thereby creating an amplified laser pulse. Various examples of the apparatus can include one or more the following.

A temporal intensity profile of the amplified laser pulse can be characterized by a quality factor, Q, of greater than or equal to 1, where Q is obtained by the following expression:

$$Q = \frac{{τ}_{FWHM}}{2 {τ}_{C}} ,$$

where τ_{FWHM} is the pulse duration of the conditioned laser pulse, and τ_{c} is obtained by the following expression:

τ_{c}=\sqrt{ [symbol]t² [symbol] − [symbol] t [symbol] ²},

where

[symbol]

t² [symbol] =∫_{-∞}^{+∞}t²I(t)dt and [symbol] t [symbol] =∫_{-∞}^{+∞}tI(t)dt,

where t is time (e.g., measured in seconds) and I(t) is laser pulse intensity as a function of time.

At least one of the pulse conditioner and the amplifier can be further configured to at least quasi-linearly chirp the conditioned laser pulse.

The apparatus can also include a pulse compressor configured to temporally compress the amplified laser pulse, thereby generating a compressed laser pulse. A temporal intensity profile of the compressed laser pulse can be characterized by a quality factor, Q, of greater than or equal to 0.2, where Q is obtained by the following expression:

$$Q = \frac{{τ}_{FWHM}}{2 {τ}_{C}} ,$$

where τ_{FWHM} is the pulse duration of the compressed laser pulse, and τ_{c} is obtained by the following expression:

τ_{c}=\sqrt{ [symbol]t² [symbol] − [symbol] t [symbol] ²},

where

[symbol]

t² [symbol] =∫_{-∞}^{+∞}t²I(t)dt and [symbol] t [symbol] =∫_{-∞}^{+∞}tI(t)dt,

where t is time (e.g., measured in seconds) and I(t) is laser pulse intensity as a function of time.

A first example of a method is carried out as follows. A temporal intensity profile of an input laser pulse is modified, thereby creating a conditioned laser pulse having conditioned temporal intensity profile characterized by a misfit parameter, M, of less than 0.13, where M is obtained by the following expression:

$${M}^{2} = \frac{\int {[ {\vert ψ \vert}^{2} - {\vert {ψ}_{Pfit} \vert}^{2} ]}^{2} d t}{\int {\vert ψ \vert}^{4} d t} ,$$

where |Ψ(t)|2 represents the pulse temporal intensity profile of the conditioned laser pulse and |ΨPfit(t)|2 represents a parabolic fit of the conditioned laser pulse. The conditioned laser pulse is amplified, thereby creating an amplified laser pulse.

A second example of a method is carried out as follows. A temporal intensity profile of an input laser pulse having a pulse duration of at least 1 ps is modified to create a conditioned laser pulse. The conditioned laser pulse is amplified to create an amplified laser pulse. The amplified laser pulse is temporally compressed to generate a compressed laser pulse having a compressed pulse duration less than the input pulse duration.

### BRIEF DESCRIPTION OF THE DRAWINGS

FIG. 1 schematically illustrates one embodiment of an apparatus for generating ultrashort laser pulses.

FIGS. 2 and 3 illustrate exemplary the autocorrelation trace of the temporal intensity and spectral profiles, respectively, of an input laser pulse that may be conditioned, amplified and optionally compressed by the apparatus shown in FIG. 1.

FIG. 4 illustrates an exemplary autocorrelation trace of the temporal intensity profile of a conditioned laser pulse created within a pulse conditioning stage of the apparatus shown in FIG. 1.

FIG. 5 illustrates an exemplary spectral profile of the conditioned laser pulse created within the pulse conditioning stage of the apparatus shown in FIG. 1.

FIG. 6 illustrates an exemplary spectral profile of the amplified laser pulse created within the amplifying stage of the apparatus shown in FIG. 1.

FIG. 7 illustrates an exemplary autocorrelation trace of the temporal intensity profile of a compressed laser pulse generated by the apparatus shown in FIG. 1.

FIG. 8 illustrates an exemplary spectral profile of an amplified laser pulse that would be created within the amplifying stage of the apparatus shown in FIG. 1 if the pulse conditioning stage was omitted.

FIG. 9 illustrates an exemplary autocorrelation trace of the temporal intensity profile of a compressed laser pulse that would be generated by the apparatus shown in FIG. 1 if the pulse conditioning stage was omitted.

### DETAILED DESCRIPTION OF THE ILLUSTRATED EMBODIMENTS

Example embodiments are described below with reference to the accompanying drawings. Many different forms and embodiments are possible without deviating from the spirit and teachings of the invention and so the disclosure should not be construed as limited to the example embodiments set forth herein. Rather, these example embodiments are provided so that this disclosure will be thorough and complete, and will convey the scope of the invention to those skilled in the art. In the drawings, the sizes and relative sizes of components may be exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

Embodiments of the present invention can facilitate the generation of very high peak power femtosecond or picosecond laser pulses in fiber laser amplifiers without suffering from the negative influence of non-linear effects such as self-phase modulation (SPM). Embodiments of the present invention also facilitate the generation of amplified laser pulses that can be temporally compressed to a very short duration to generate a laser pulse having a temporal intensity profile that is suitable for material processing applications. Embodiments of the present invention also facilitate the generation of laser pulses having pulse durations on the order of one to several tens of picoseconds and further having other characteristics (e.g., average power, pulse energy, pulse repetition rate, etc.) that are typically available from laser systems generated laser pulses having substantially longer pulse durations (e.g., in the nanosecond regime), without the cost or complexity of CPA systems.

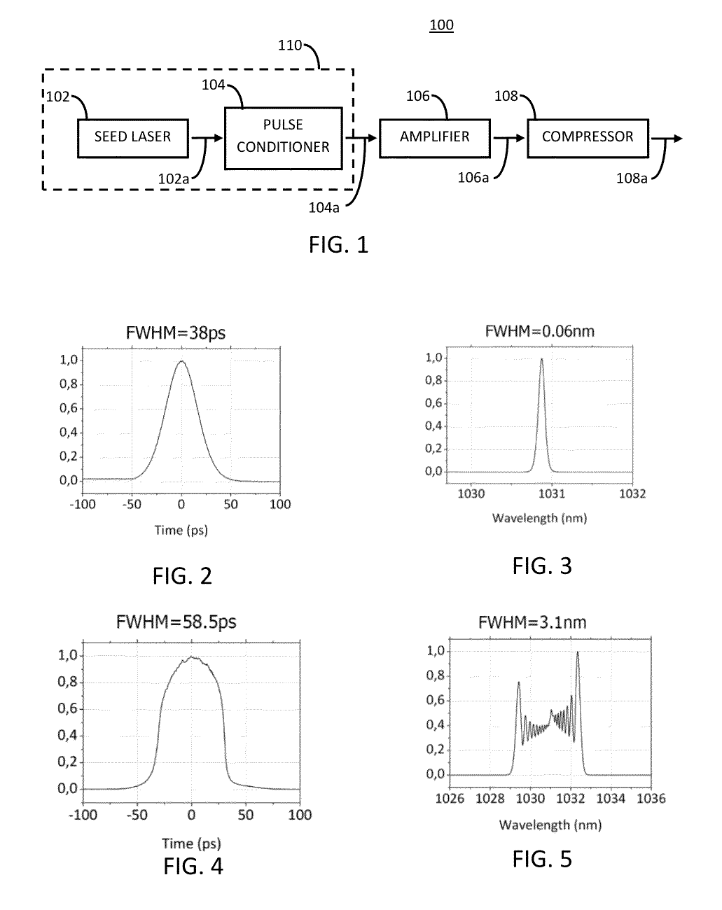

Referring to FIG. 1, an apparatus, such as apparatus 100, for generating ultrashort laser pulses can include a seed laser 102, a pulse conditioner 104 optically coupled to an output of the seed laser 102, an amplifier 106 optically coupled to an output of the pulse conditioner 104, and an optional pulse compressor 108 optically coupled to an output of the amplifier 106. Considered together, the seed laser 102 and the pulse conditioner 104 can be collectively referred to herein as a “parabolic pulse source.”

Generally, the seed laser 102 is configured to generate input laser pulses, which can be output from the seed laser 102 to the pulse conditioner 104 (e.g., as indicated by arrow 102a). The seed laser 102 can be provided as a laser oscillator such as a mode-locked solid-state bulk laser, a mode-locked fiber laser, a mode-locked diode laser, a Q-switched laser, a gain-switched laser, or the like or a combination thereof. In one embodiment, the seed laser 102 is provided as a picosecond laser oscillator. Input laser pulses are output from the seed laser 102 at a pulse repetition rate in a range from 20 kHz to 200 MHz, or thereabout. In one embodiment, input laser pulses are output from the seed laser 102 at a pulse repetition rate in a range from 100 kHz to 80 MHz (e.g., in a range from 100 kHz to 50 MHz). It will be appreciated that the desired pulse repetition rate may be attained either by directly generating the input laser pulses at the set pulse repetition rate using the laser oscillator or indirectly by implementing any suitable or beneficial pulse picking method (e.g., in which the pulse repetition rate of laser pulses generated by a laser oscillator is effectively adjusted using a free-space or a fiber-coupled acousto-optic pulse picker that is externally synchronized on the oscillator repetition rate and driven by an electric signal that sets the final repetition rate in the range of 10 kHz to 100 MHz).

Generally, the input laser pulses that are output by the seed laser 102 have a temporal intensity profile that has a Gaussian profile, a sech2 profile, a Lorentzian profile, or a profile that can otherwise be characterized by a misfit parameter, M, that is greater than or equal to 0.13, where M is obtained by the following expression:

$${M}^{2} = \frac{\int {[ {\vert ψ \vert}^{2} - {\vert {ψ}_{Pfit} \vert}^{2} ]}^{2} d t}{\int {\vert ψ \vert}^{4} d t} ,$$

where |Ψ(t)|2 represents the pulse temporal intensity profile of the conditioned laser pulse and |ΨPfit(t)|2 represents a parabolic fit of the conditioned laser pulse. An exemplary autocorrelation trace of the temporal intensity profile of an input laser pulse output by the seed laser 102 is shown in FIG. 2.

The seed laser 102 can be operated such that input laser pulses ultimately output by the seed laser 102 can have an input pulse duration (i.e., measured in terms of pulse duration at the full width-half maximum, or “FWHM”) in a range from 1 picosecond (ps) to 100 ps, or thereabout. In one embodiment, the input pulse duration can be in a range from 15 ps to 50 ps. As shown in FIG. 2, an input pulse duration of an input laser pulse may be 38 ps. The seed laser 102 can be configured such that the input laser pulses that are output therefrom have an input spectral bandwidth (i.e., measured at FWHM) in a range from 0.01 nanometer (nm) to 1 nm, or thereabout. In one embodiment, the input spectral bandwidth is in a range from 0.01 nm to 0.3 nm (e.g., 0.03 nm to 0.15 nm). As shown in FIG. 3, an exemplary input spectral bandwidth of an input laser pulse output by the seed laser 102 can be 0.06 nm. The seed laser 102 can further be configured such that the input laser pulses have an input central wavelength in a range from 260 nm to 2600 nm, or thereabout. In one embodiment, the input central wavelength is in the ultraviolet (UV) spectrum (e.g., 343 nm, or thereabout), in the visible spectrum (e.g., 515 nm, or thereabout), or in the infrared (IR) spectrum (e.g., 1030 nm, or thereabout). As shown in FIG. 3, an exemplary input central bandwidth of an input laser pulse output by the seed laser 102 can be slightly less than 1031 nm). Lastly, the seed laser 102 can configured such that each input laser pulse has an input pulse energy in a range from 10 picojoules (pJ) to 10 nanojoules (nJ), or thereabout. In one embodiment, the input pulse energy of one or more input laser pulses can be in a range from 100 pJ to 5 nJ (e.g., in a range from 500 pJ to 3 nJ).

The pulse conditioner 104 is configured to receive input laser pulses output from the seed laser 102, modify the received laser pulses to thereby form conditioned laser pulses, and output the conditioned laser pulses to the amplifier 106 (e.g., as indicated by arrow 104a). Generally, the pulse conditioner 104 includes an optical fiber (e.g., a single mode, normally dispersive optical fiber) having a first end (i.e., where the input laser pulses are received from the seed laser 102) and a second end opposite the first end (i.e., where the conditioned laser pulses are transmitted to the amplifier 106). As each input laser pulse is transmitted within the optical fiber from the first end to the second end, each laser pulse undergoes SPM and group velocity dispersion (GVD) to thereby become a conditioned laser pulse.

Travelling within the optical fiber, the temporal intensity profile of the input laser pulse becomes modified due to the joint action of GVD and SPM so that the conditioned laser pulse attains a conditioned pulse duration greater than the input laser pulse duration of the input laser pulse. For example, the conditioned pulse duration of a conditioned laser pulse may be in a range from 1.5 to 5 times greater (or thereabout) than the input laser pulse duration of the input laser pulse. In one embodiment, the conditioned pulse duration can be in a range 1.5 to 2.5 times greater than the input laser pulse duration. As shown in FIG. 4, a conditioned pulse duration of a conditioned laser pulse output by the pulse conditioner 104 may be 58.5 ps.

Also, as each input laser pulses travels through the optical fiber, GVD and SPM modify the temporal intensity profile of the input laser pulse such that the conditioned laser pulse attains a temporal intensity profile (e.g., at least a quasi-parabolic temporal intensity profile) such as that shown in FIG. 4. Generally, when characterized by the aforementioned misfit parameter M, the conditioned temporal intensity profile has an M value of less than 0.13. In one embodiment, the conditioned temporal intensity profile has a value of M that is in a range from 0.11 to 0.01, or thereabout.

Further, as each input laser pulse is transmitted from the first end to the second end of the optical fiber, the input laser pulse also becomes at least quasi-linearly chirped, so that the resultant conditioned laser pulse attains a spectral profile having a conditioned spectral bandwidth as shown in FIG. 5. Generally, the conditioned spectral bandwidth of a conditioned laser pulse will be greater than the input spectral bandwidth of the input laser pulse (e.g., in a range from 20 to 100 times the input spectral bandwidth, or thereabout). In one embodiment, the conditioned spectrum bandwidth is a range from 0.1 nm to 10 nm, or thereabout. For example, the conditioned spectrum bandwidth can be a range from 0.3 nm to 8 nm (e.g., in a range from 1 nm to 5 nm). As shown in FIG. 5, an exemplary conditioned spectral bandwidth of a conditioned laser pulse output by the pulse conditioner 104 can be 3.1 nm.

The optical fiber has a length, measured from the first end to the second end, in a range from 50 m to 2000 m, or thereabout. In one embodiment, the optical fiber may have a length in a range from 50 m to 500 m (e.g., 100 m to 400 m). The optical fiber may have a core diameter in a range from 3 μm to 25 μm, or thereabout. In one embodiment, the core diameter of the optical fiber may be in a range from 4 μm to 15 μm (e.g., in a range from 6 μm to 10 μm). The optical fiber may have a nonlinear refractive index in a range from 1×10-16 cm2/W to 10×10-16 cm2/W, or thereabout. In one embodiment, the nonlinear refractive index of the optical fiber may be in a range from 2×10-16 cm2/W to 5×10-16 cm2/W (e.g., in a range from 2.5×10-16 cm2/W to 3.5×10-16 cm2/W). The optical fiber may have a group velocity dispersion in a range from 0.001 ps2/m to 0.25 ps2/m, or thereabout. In one embodiment, the group velocity dispersion of the optical fiber may be in a range from 0.02 ps2/m to 0.15 ps2/m (e.g., in a range from 0.02 ps2/m to 0.05 ps2/m). Generally, the aforementioned characteristics of the optical fiber can be adjusted depending upon characteristics (e.g., central wavelength, pulse duration, peak power, etc.) of the input laser pulse to achieve the proper balance between SPM and GVD which yields a conditioned laser pulse having an at least quasi-parabolic temporal intensity profile. For example, the length and/or group velocity dispersion of the optical fiber can be increased with increasing input pulse duration. Further, the length of the optical fiber and the peak power input laser pulses (as well as the input pulse duration of each input laser pulse) can be calculated to provide a desired or beneficial balance of Self Phase Modulation (SPM) and Group Velocity Dispersion (GVD) in order to produce a conditioned laser pulse with the desired or beneficial temporal intensity profile and spectral chirp. Depending upon one or more characteristics of the optical fiber (e.g., the length of the optical fiber), the input laser pulse (e.g., the input pulse duration, input pulse energy, etc.), or a combination thereof, the conditioned laser pulse may be characterized as having a solution number N, in a range from 2 to 100. In one embodiment, N may be in a range from 2 to 64 (e.g., 2.4, or thereabout).

The amplifier 106 is configured to receive conditioned laser pulses output from the pulse conditioner 104, increase the power of the conditioned laser pulses to thereby form amplified laser pulses, and output the amplified laser pulses (e.g., as indicated by arrow 106a). In one embodiment, the amplifier 106 may be configured to generate amplified laser pulses having a peak power in a range from 1 kW to 4 MW, or thereabout.

Generally, the amplifier 106 may be provided as a single-stage optical amplification system, or as a multi-stage amplification system. For example, the amplifier 106 may include a pre-amplifier stage configured to amplify the conditioned laser pulse and thereby create a preliminary amplified laser pulse, and a power amplifier stage configured to further amplify the preliminary amplified laser pulse and thereby create the aforementioned amplified laser pulse. An amplifier stage may include a fiber amplifier having a length less than 20 m (e.g., less than 3 m) and including, for example, a silica core (e.g., having a diameter in a range from 20 μm to 100 μm, or thereabout) doped with dopant ions such as erbium, neodymium, ytterbium, praseodymium, thulium, or the like or a combination thereof. In one embodiment, the fiber amplifier may include a multimode optical fiber, a singlemode fiber or a combination thereof. In other embodiments, an amplifier stage may include a multipass amplifier, a regenerative amplifier, or the like or a combination thereof. Within an amplification stage, the gain media of an amplifier can be chosen to have large core diameter and small pump clad diameter in order to increase the fiber absorption and reduce its length. As an example, a pre-amplifier stage may be provided with a 40 μm core rod-type fiber that is pumped using a 50 W diode laser running at 976 nm, and a power amplifier stage may be provided with a 75 μm rod-type fiber that is pumped using a 200 W diode laser running at 976 nm. The two amplifier stages may be isolated using an optical isolator.

Constructed as described above, the amplifier 106 amplifies each conditioned laser pulse to create an amplified laser pulse. In the amplifier 106, the conditioned laser pulses experience strong SPM, but experience no (or at least substantially no) GVD because the length of the amplifier 106 is relatively small. Because the temporal intensity profile of each conditioned laser pulse is at least quasi-parabolic as discussed above, any SPM within the amplifier 106 induces a quasi-parabolic phase on the laser pulse as it is amplified. As a result, an amplified laser pulse output by the amplifier 106 at least substantially retains the temporal intensity profile and pulse duration of the conditioned laser pulse from which it was created. As a result, the temporal intensity profile of each amplified laser pulse output by the amplifier 106 can be characterized by a quality factor, Q, that has a value that is greater than or equal to 1. In some embodiments, the Q factor of the amplified laser pulses can be up to 1.8 or more. For the purposes of discussion herein, the quality factor, Q, is obtained by the following expression:

$$Q = \frac{{τ}_{FWHM}}{2 {τ}_{C}} ,$$

where τ_{FWHM} is the pulse duration of the compressed laser pulse, and τ_{c} is obtained by the following expression:

τ_{c}=\sqrt{ [symbol]t² [symbol] − [symbol] t [symbol] ²},

where

[symbol]

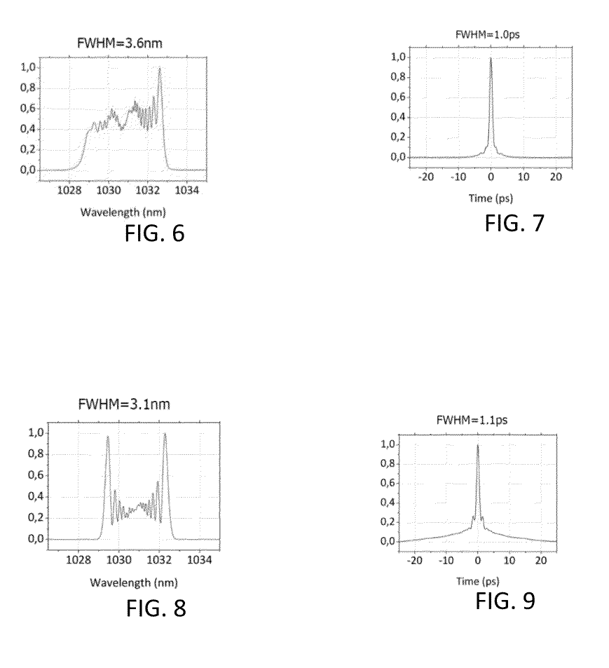

t² [symbol] =∫_{-∞}^{+∞}t²I(t)dt and [symbol] t [symbol] =∫_{-∞}^{+∞}tI(t)dt,

where t is time (e.g., measured in seconds) and I(t) is laser pulse intensity as a function of time. The quasi-parabolic phase induced within the amplifier 106 keeps any additional chirp within the amplifier 106 to beat least substantially linear even in the presence of very strong non-linearities. Thus, amplified laser pulses output by the amplifier 106 attain a spectral profile as illustrated in FIG. 6. As shown in FIG. 6, an exemplary spectral bandwidth of an amplified laser pulse output by the amplifier 106 can be 3.6 nm.

When present with the apparatus 100, the pulse compressor 108 is configured to receive amplified laser pulses output from the amplifier 106, de-chirp the amplified laser pulses to thereby form compressed laser pulses that are temporally compressed compared to the amplified laser pulses, and output the compressed laser pulses (e.g., as indicated by arrow 108a). Generally, the pulse compressor 108 is provided as a dispersive pulse compressor (e.g., including a pair of diffraction gratings, a prism pair, an optical fiber, a chirped mirror, a chirped fiber Bragg grating, a volume Bragg grating, or the like or a combination thereof) configured to de-chirp the linearly chirped spectrum of the amplified laser pulses. In one embodiment, the pulse compressor 108 is provided as a pair of 1800 l/mm gratings.

Upon de-chirping the amplified laser pulses, the parabolic phase of the temporal intensity profile in each amplified laser pulse is temporally compressed and the spectral bandwidth of the compressed laser pulses output by the pulse compressor 108 is essentially similar to the spectral bandwidth of the amplified laser pulses output by the amplifier 106.

Each compressed laser pulse may have a compressed pulse duration less than the pulse duration of the laser pulse from which it was created. For example, the compressed pulse duration may be in a range from 10 to 100 times less than the conditioned pulse duration (which is at least substantially the same pulse duration as the amplified laser pulse). Further, the compressed pulse duration may be in a range from 10 to 60 times less than the input laser pulse duration. In one embodiment, the compressed pulse duration may be in a range from 0.1 ps to 10 ps, or thereabout. For example, the compressed pulse duration may be in a range from 0.3 ps to 3 ps (e.g., in a range from 0.5 ps to 1.5 ps). FIG. 7 illustrates an exemplary autocorrelation trace of a temporal intensity profile of a compressed laser pulse having a compressed pulse duration of 1.0 ps. Upon temporally compressing the amplified laser pulses, each compressed laser pulse can attain a peak power in range from 10 kW to 500 MW.

Because the input laser pulses output by the seed laser 102 are at least substantially linearly chirped (e.g., first by the pulse conditioner 104 and subsequently by the amplifier 106), and because the temporal intensity profile of the conditioned laser pulses output by the pulse conditioner 104 is at least substantially retained by the amplified laser pulses output by the amplifier 106, the compressed laser pulses output by the pulse compressor 108 have a temporal intensity profile making them beneficially suitable for use in material processing applications. Specifically, the temporal intensity profile of each compressed laser pulse output by the pulse compressor 108 can be characterized by a quality factor, Q, that has a value in a range from 0.2 to 0.5. However, depending upon factors such as the degree to which the amplified laser pulse is compressed to create the compressed laser pulse, the quality factor of the amplified laser pulse, etc., the quality factor of the compressed laser pulse output by the pulse compressor 108 can be greater 0.5. If the aforementioned pulse conditioner 104 were omitted from the apparatus 100, then the spectral profile of the amplified laser pulses output by the amplifier 106 would be significantly non-linearly chirped, as shown in FIG. 8. As a result, the compressed laser pulses output by the pulse compressor 108 would attain a temporal intensity profile as exemplarily shown in FIG. 9, which has a Q factor value of 0.06. Laser pulses having a temporal intensity profile such as that shown in FIG. 9 are not suitable for material processing applications because the local power of such laser pulses at 5 times the FWHM pulse duration is greater than 1% of the peak power of the laser pulse.

### EXAMPLE

In one exemplary implementation of the embodiments discussed above, the seed laser 102 may be provided as a mode-locked laser delivering Fourier-transform limited pulses, having an input pulse duration in a range from 15 ps to 50 ps (e.g., 38 ps) and an input temporal intensity profile (e.g., a Gaussian profile) such as that should in FIG. 2 and a spectral profile such as that shown in FIG. 3.

Input laser pulses generated by the seed laser 102 are transmitted into the pulse conditioner 104, which is provided as a fused silica single mode optical fiber (e.g., a telecommunications fiber). While propagating through the optical fiber, the input laser pulse undergoes SPM and group velocity dispersion (GVD) to thereby become a conditioned laser pulse. The temporal intensity profile of the input laser pulse becomes conditioned due to the joint action of GVD and SPM so that the conditioned laser pulse attains a temporal intensity profile (e.g., at least a quasi-parabolic temporal intensity profile) such as that shown in FIG. 4. The input laser pulse becomes at least quasi-linearly chirped and the conditioned laser pulse attains a spectral profile as shown in FIG. 5. The length of the optical fiber and the peak power and pulse duration of the input laser pulses are carefully calculated to provide the right balance of Self Phase Modulation (SPM) and Group Velocity Dispersion (GVD) in order to produce a pulse with the aforementioned temporal intensity profile and a spectral chirp.

The conditioned pulses are then sent to a fiber amplifier 106 (e.g., comprised of one or more Yb-doped fiber amplifier stages) where the laser pulses can be amplified by a factor of 104 to 106, to produce amplified laser pulses having a peak power up to 1 MW. In the amplifier 106, the conditioned laser pulses experience strong SPM, but experience no (or at least substantially no) GVD because the length of the amplifier 106 is relatively small (e.g., less than 3 m). Because the temporal intensity profile of each conditioned laser pulse is at least quasi-parabolic as discussed above, any SPM within the amplifier 106 induces a quasi-parabolic phase on the laser pulse as it is amplified. As a result, amplified laser pulses at least substantially retain the temporal intensity profile as shown in FIG. 4. The quasi-parabolic phase induced within the amplifier 106 keeps the chirp within the amplifier 106 at least substantially linear even in the presence of very strong non-linearities. Thus, each amplified laser pulse attains a spectral profile as illustrated in FIG. 6.

In one embodiment, the amplified laser pulses generated at the output 106a of amplifier 106—which have pulse durations on the order of 1 to several tens of picoseconds—can be used as desired for material processing applications. In another embodiment, however, the amplified laser pulses generated at the output 106a of amplifier 106 can be sent to the compressor 108 (e.g., a pair of diffraction gratings, a chirped Volume Bragg Grating (VBG), etc.), where the compressor can de-chirp the linearly chirped spectrum of the amplified laser pulses thereby temporally compressing the amplified laser pulses to a compressed pulse duration that is 10 to 60 times shorter than the input pulse duration. Advantageously, the temporal intensity profile of the compressed laser pulses is beneficially suitable for material processing applications because the laser pulses have been at least substantially linearly chirped at various stages within the apparatus. The compressor 108 compresses the parabolic phase of the temporal intensity profile of the amplified laser pulses. Thus, if the pulse conditioner 104 was omitted, the temporal intensity profile of the amplified laser pulses would predominately Gaussian and the compressed laser pulse would attain a temporal intensity profile such as that shown in FIG. 9, which is unsuitable for material processing applications.

The foregoing is illustrative of example embodiments of the invention and is not to be construed as limiting thereof. Although a few example embodiments have been described, those skilled in the art will readily appreciate that many modifications are possible without materially departing from the novel teachings and advantages of the invention. Accordingly, all such modifications are intended to be included within the scope of the invention as defined in the following claims.

The following clauses describe aspects of various examples of apparatus and methods according to the above described technology.

1. An apparatus, comprising:

a pulse conditioner configured to modify a temporal intensity profile of an input laser pulse, thereby creating a conditioned laser pulse having conditioned temporal intensity profile characterized by a misfit parameter, M, of less than 0.13, where M is obtained by the following expression:

$${M}^{2} = \frac{\int {[ {\vert ψ \vert}^{2} - {\vert {ψ}_{Pfit} \vert}^{2} ]}^{2} d t}{\int {\vert ψ \vert}^{4} d t} ,$$

where |Ψ(t)|2 represents the pulse temporal intensity profile of the conditioned laser pulse and |ΨPfit(t)|2 represents a parabolic fit of the conditioned laser pulse; and

an amplifier coupled to an output of the pulse conditioner source and configured to increase the power of the conditioned laser pulse, thereby creating an amplified laser pulse.

2. The apparatus of clause 1, wherein the pulse conditioner is further configured to broaden a spectral bandwidth of the input laser pulse such that the conditioned laser pulse has a conditioned spectral bandwidth.

3. The apparatus of any of clauses 1 to 2, wherein the pulse conditioner is further configured to at least quasi-linearly chirp the input laser pulse.

4. The apparatus of any of clauses 1 to 3, wherein the temporal intensity profile of the amplified laser pulse has a shape that is at least substantially the same as that of the conditioned laser pulse.

5. The apparatus of any of clauses 1 to 4, wherein the temporal intensity profile of the amplified laser pulse is characterized by a quality factor, Q, of greater than or equal to 1, where Q is obtained by the following expression:

$$Q = \frac{{τ}_{FWHM}}{2 {τ}_{C}} ,$$

where τ_{FWHM} is the pulse duration of the conditioned laser pulse, and τ_{c} is obtained by the following expression:

τ_{c}=\sqrt{ [symbol]t² [symbol] − [symbol] t [symbol] ²},

where

[symbol]

t² [symbol] =∫_{-∞}^{+∞}t²I(t)dt and [symbol] t [symbol] =∫_{-∞}^{+∞}tI(t)dt,

where t is time (e.g., measured in seconds) and I(t) is laser pulse intensity as a function of time.

6. The apparatus of clause 5, wherein the temporal intensity profile of the amplified laser pulse is characterized by a quality factor, Q, of less than or equal to 1.8.

7. The apparatus of any of clauses 1 to 6, wherein the amplifier is further configured to at least quasi-linearly chirp the conditioned laser pulse.

8. The apparatus of any of clauses 1 to 7, further comprising a pulse compressor configured to temporally compress the amplified laser pulse, thereby generating a compressed laser pulse.

9. The apparatus of clause 8, wherein the pulse compressor configured to de-chirp the amplified laser pulse.

10. The apparatus of any of clauses 8 to 9, wherein the temporal intensity profile of the compressed laser pulse is characterized by a quality factor, Q, of greater than or equal to 0.2, where Q is obtained by the following expression:

$$Q = \frac{{τ}_{FWHM}}{2 {τ}_{C}} ,$$

where τ_{FWHM} is the pulse duration of the compressed laser pulse, and τ_{c} is obtained by the following expression:

τ_{c}=\sqrt{ [symbol]t² [symbol] − [symbol] t [symbol] ²},

where

[symbol]

t² [symbol] =∫_{-∞}^{+∞}t²I(t)dt and [symbol] t [symbol] =∫_{-∞}^{+∞}tI(t)dt,

where t is time (e.g., measured in seconds) and I(t) is laser pulse intensity as a function of time.

11. The apparatus of clause 10, wherein the temporal intensity profile of the compressed laser pulse is characterized by a quality factor, Q, of less than or equal to 0.5.

12. The apparatus of any of clauses 1 to 11, further comprising a seed laser configured to generate the input laser pulse.

13. An apparatus, comprising:

a parabolic pulse source configured to generate a laser pulse having a temporal intensity profile characterized by a misfit parameter, M, of less than 0.13, where M is obtained by the following expression:

$${M}^{2} = \frac{\int {[ {\vert ψ \vert}^{2} - {\vert {ψ}_{Pfit} \vert}^{2} ]}^{2} d t}{\int {\vert ψ \vert}^{4} d t} ,$$

where |Ψ(t)|2 represents the pulse temporal intensity profile of the laser pulse and |ΨPfit(t)|2 represents a parabolic fit of the laser pulse; and

an amplifier coupled to an output of the parabolic pulse source and configured to increase the power of the laser pulse, thereby creating an amplified laser pulse.

14. The apparatus of clause 13, wherein the parabolic pulse source comprises:

a seed laser configured to generate an input laser pulse having an input temporal intensity profile; and

a pulse conditioner configured to modify the input temporal intensity profile, thereby creating the laser pulse having the temporal intensity profile characterized by an M value of less than 0.13.

15. The apparatus of any of clauses 13 to 14, further comprising a pulse compressor configured to temporally compress the amplified laser pulse, thereby generating a compressed laser pulse.

16. An apparatus, comprising:

a pulse conditioner configured to modify a temporal intensity profile of an input laser pulse having a pulse duration of at least 1 ps, thereby creating a conditioned laser pulse;

an amplifier coupled to an output of the pulse conditioner source and configured to increase the power of the conditioned laser pulse, thereby creating an amplified laser pulse; and

a pulse compressor configured to temporally compress the amplified laser pulse, thereby generating a compressed laser pulse having a compressed pulse duration less than the input pulse duration.

17. The apparatus of any of clauses 1 to 16, wherein the pulse conditioner comprises an optical fiber having a first end and a second end opposite the first end.

18. The apparatus of clause 17, wherein the optical fiber is a single mode fiber.

19. The apparatus of any of clauses 17 to 18, wherein the optical fiber is a normally dispersive optical fiber.

20. The apparatus of any of clauses 17 to 19, wherein the length of the optical fiber from the first end to the second end is in a range from 50 m to 2000 m.

21. The apparatus of any of clauses 17 to 20, wherein the length of the optical fiber from the first end to the second end is in a range from 50 m to 500 m.

22. The apparatus of any of clauses 17 to 21, wherein the length of the optical fiber from the first end to the second end is in a range from 100 m to 400 m.

23. The apparatus of any of clauses 17 to 22, wherein the optical fiber has a core diameter in a range from 3 μm to 25 μm.

24. The apparatus of any of clauses 17 to 23, wherein the optical fiber has a core diameter in a range from 4 μm to 15 μm.

25. The apparatus of any of clauses 17 to 24, wherein the optical fiber has a core diameter in a range from 6 μm to 10 μm.

26. The apparatus of any of clauses 17 to 25, wherein the optical fiber has a nonlinear refractive index in a range from 1×10-16 cm2/W to 10 x 10-16 cm2/W

27. The apparatus of any of clauses 17 to 26, wherein the optical fiber has a nonlinear refractive index in a range from 2×10-16 cm2/W to 5×10-16 cm2/W.

28. The apparatus of any of clauses 17 to 27, wherein the optical fiber has a nonlinear refractive index in a range from 2.5×10-16 cm2/W to 3.5×10-16 cm2/W.

29. The apparatus of any of clauses 17 to 28, wherein the optical fiber has a group velocity dispersion in a range from 0.001 ps2/m to 0.25 ps2/m.

30. The apparatus of any of clauses 17 to 29, wherein the optical fiber has a group velocity dispersion in a range from 0.02 ps2/m to 0.15 ps2/m.

31. The apparatus of any of clauses 17 to 30, wherein the optical fiber has a group velocity dispersion in a range from 0.02 ps2/m to 0.05 ps2/m.

32. The apparatus of any of clauses 1 to 31, wherein the conditioned laser pulse has a conditioned temporal intensity profile with a value of M that is less than or equal to 0.11.

33. The apparatus of any of clauses 1 to 32, wherein the conditioned laser pulse has a conditioned temporal intensity profile with a value of M that less than or equal to 0.10.

34. The apparatus of any of clauses 1 to 33, wherein the conditioned laser pulse has a conditioned temporal intensity profile with a value of M that is less than or equal to 0.09.

35. The apparatus of any of clauses 1 to 34, wherein the conditioned laser pulse has a conditioned temporal intensity profile with a value of M that is less than or equal to 0.08.

36. The apparatus of any of clauses 1 to 35, wherein the conditioned laser pulse has a conditioned temporal intensity profile with a value of M that is less than or equal to 0.07.

37. The apparatus of any of clauses 1 to 36, wherein the conditioned laser pulse has a conditioned temporal intensity profile with a value of M that is less than or equal to 0.06.

38. The apparatus of any of clauses 1 to 37, wherein the conditioned laser pulse has a conditioned temporal intensity profile with a value of M that is less than or equal to 0.05.

39. The apparatus of any of clauses 1 to 38, wherein the conditioned laser pulse has a conditioned temporal intensity profile with a value of M that is less than or equal to 0.04.

40. The apparatus of any of clauses 1 to 39, wherein the conditioned laser pulse has a conditioned temporal intensity profile with a value of M that is less than or equal to 0.03.

41. The apparatus of any of clauses 1 to 40, wherein the conditioned laser pulse has a conditioned temporal intensity profile with a value of M that is less than or equal to 0.02.

42. The apparatus of any of clauses 1 to 41, wherein the conditioned laser pulse has a conditioned temporal intensity profile with a value of M that is less than or equal to 0.01.

43. The apparatus of any of clauses 1 to 42, wherein the input laser pulse has an input temporal intensity profile with a value of M greater than the value of M for the conditioned temporal intensity profile.

44. The apparatus of clause 43, wherein the value of M for the input temporal intensity profile is 0.13 or greater.

45. The apparatus of any of clauses 1 to 44, wherein the input temporal intensity profile of the input laser pulse is a Gaussian profile.

46. The apparatus of any of clauses 1 to 45, wherein the input temporal intensity profile of the input laser pulse is a sech2 profile.

47. The apparatus of any of clauses 1 to 46, wherein the input temporal intensity profile of the input laser pulse is a Lorentzian profile.

48. The apparatus of any of clauses 1 to 47, wherein the input laser pulse has an input pulse duration greater than 1 ps.

49. The apparatus of any of clauses 1 to 48, wherein the input laser pulse has an input pulse duration less than 100 ps.

50. The apparatus of any of clauses 1 to 49, wherein the input laser pulse has an input pulse duration in a range from 15 ps to 50 ps.

51. The apparatus of any of clauses 1 to 50, wherein the conditioned laser pulse has a conditioned pulse duration greater than the input laser pulse duration of the input laser pulse.

52. The apparatus of any of clauses 1 to 51, wherein the conditioned pulse duration is in a range from 1.5 to 5 times greater than the input laser pulse duration.

53. The apparatus of any of clauses 1 to 52, wherein the conditioned pulse duration is in a range 1.5 to 2.5 times greater than the input laser pulse duration.

54. The apparatus of any of clauses 1 to 53, wherein the compressed laser pulse has a compressed pulse duration less than the conditioned pulse duration of the conditioned laser pulse.

55. The apparatus of clause 54, wherein the compressed pulse duration is in a range from 10 to 100 times less than the conditioned pulse duration.

56. The apparatus of any of clauses 54 to 55, wherein the compressed laser pulse has a compressed pulse duration less than the input laser pulse duration of the input laser pulse.

57. The apparatus of clause 56, wherein the compressed pulse duration is in a range from 10 to 60 times less than the input laser pulse duration.

58. The apparatus of any of clauses 54 to 57, wherein the compressed pulse duration is in a range from 0.1 ps to 10 ps.

59. The apparatus of any of clauses 54 to 58, wherein the compressed pulse duration is in a range from 0.3 ps to 3 ps.

60. The apparatus of any of clauses 54 to 59, wherein the compressed pulse duration is in a range from 0.5 ps to 1.5 ps.

61. The apparatus of any of clauses 1 to 61, wherein the input laser pulse has an input spectral bandwidth in a range from 0.01 nm to 1 nm.

62. The apparatus of 61, wherein the input spectral bandwidth is in a range from 0.01 nm to 0.3 nm.

63. The apparatus of any of clauses 61 to 62, wherein the input spectral bandwidth is in a range from 0.03 nm to 0.15 nm.

64. The apparatus of any of clauses 1 to 63, wherein the conditioned laser pulse has a conditioned spectral bandwidth greater than an input spectral bandwidth of the input laser pulse.

65. The apparatus of clause 64, wherein the conditioned spectral bandwidth is in a range from 20 to 100 times the input spectral bandwidth.

66. The apparatus of any of clauses 64 to 65, wherein the conditioned spectral bandwidth is in a range from 0.1 nm to 10 nm.

67. The apparatus of any of clauses 64 to 66, wherein the conditioned spectral bandwidth is in a range from 0.3 nm to 8 nm.

68. The apparatus of any of clauses 64 to 67, wherein the conditioned spectral bandwidth is in a range from 1 nm to 5 nm.

69. The apparatus of any of clauses 1 to 68, wherein the input laser pulse has an input central wavelength greater than 260 nm.

70. The apparatus of any of clauses 1 to 69, wherein the input laser pulse has an input central wavelength less than 2600 nm.

71. The apparatus of any of clauses 69 to 70, wherein the input laser pulse has an input central wavelength in the infrared spectrum.

72. The apparatus of any of clauses 69 to 70, wherein the input laser pulse has an input central wavelength in the visible spectrum.

73. The apparatus of any of clauses 69 to 70, wherein the input laser pulse has an input central wavelength in the ultraviolet spectrum.

74. The apparatus of any of clauses 1 to 73, wherein the input laser pulse has an input pulse energy in a range from 10 pJ to 10 nJ.

75. The apparatus of any of clauses 1 to 74, wherein the input laser pulse has an input pulse energy in a range from 100 pJ to 5 nJ.

76. The apparatus of any of clauses 1 to 74, wherein the input laser pulse has an input pulse energy in a range from 500 pJ to 3 nJ.

77. The apparatus of any of clauses 1 to 76, wherein the amplifier includes a fiber amplifier.

78. The apparatus of any of clauses 1 to 77, wherein the fiber amplifier comprises singlemode optical fiber.

79. The apparatus of any of clauses 1 to 78, wherein the fiber amplifier includes a silica core doped with dopant ions such as erbium, neodymium, ytterbium, praseodymium, thulium, or the like or a combination thereof.

80. The apparatus of any of clauses 1 to 79, wherein core has a diameter in a range from 20 μm to 100 μm.

81. The apparatus of any of clauses 1 to 80, wherein a length of the fiber amplifier is less than 20 m.

82. The apparatus of clause 81, wherein a length of the fiber amplifier is less than 3 m.

83. The apparatus of any of clauses 1 to 82, wherein the amplifier includes a multipass amplifier.

84. The apparatus of any of clauses 1 to 83, wherein the amplifier includes a regenerative amplifier.

85. The apparatus of any of clauses 1 to 84, wherein the amplifier includes:

a pre-amplifier configured to amplify the conditioned laser pulse, thereby creating a preliminary amplified laser pulse; and

a power amplifier stage configured to further amplify the preliminary amplified laser pulse, thereby creating the amplified laser pulse.

86. The apparatus of any of clauses 1 to 85, wherein the peak power of the amplified laser pulse is in a range from 1 kW to 4 MW.

87. The apparatus of any of clauses 1 to 86, wherein the peak power of the compressed laser pulse is in a range from 10 kW to 500 MW.

88. The apparatus of any of clauses 1 to 87, wherein the pulse compressor includes a dispersive pulse compressor.

89. The apparatus of any of clauses 1 to 88, wherein the dispersive pulse compressor includes a pair of diffraction gratings, a prism pair, an optical fiber, a chirped mirror, a chirped fiber Bragg grating, a volume Bragg grating, or the like or a combination thereof.

90. A method, comprising:

modifying a temporal intensity profile of an input laser pulse, thereby creating a conditioned laser pulse having conditioned temporal intensity profile characterized by a misfit parameter, M, of less than 0.13, where M is obtained by the following expression:

$${M}^{2} = \frac{\int {[ {\vert ψ \vert}^{2} - {\vert {ψ}_{Pfit} \vert}^{2} ]}^{2} d t}{\int {\vert ψ \vert}^{4} d t} ,$$

where |Ψ(t)|2 represents the pulse temporal intensity profile of the conditioned laser pulse and |ΨPfit(t)|2 represents a parabolic fit of the conditioned laser pulse; and amplifying the conditioned laser pulse, thereby creating an amplified laser pulse.

91. A method, comprising:

modifying a temporal intensity profile of an input laser pulse having a pulse duration of at least 1 ps, thereby creating a conditioned laser pulse;

amplifying the conditioned laser pulse, thereby creating an amplified laser pulse; and

temporally compressing the amplified laser pulse, thereby generating a compressed laser pulse having a compressed pulse duration less than the input pulse duration.

What is claimed is:

1. An apparatus, comprising:
a pulse conditioner configured to modify a temporal intensity profile of an input laser pulse, thereby creating a conditioned laser pulse having conditioned temporal intensity profile characterized by a misfit parameter, M, of less than 0.13, where M is obtained by the following expression:
$${M}^{2} = \frac{\int [ {\vert ψ \vert}^{2} - {\vert {ψ}_{Pfit} \vert}^{2} ] d t}{\int {\vert ψ \vert}^{4} d t} ,$$
where |Ψ(t)|2 represents the pulse temporal intensity profile of the conditioned laser pulse and |ΨPfit(t)|2 represents a parabolic fit of the conditioned laser pulse; and
an amplifier coupled to an output of the pulse conditioner source and configured to increase the power of the conditioned laser pulse, thereby creating an amplified laser pulse.

2. The apparatus of claim 1, wherein the pulse conditioner is further configured to broaden a spectral bandwidth of the input laser pulse such that the conditioned laser pulse has a conditioned spectral bandwidth.

3. The apparatus of claim 1, wherein a temporal intensity profile of the amplified laser pulse is characterized by a quality factor, Q, of greater than or equal to 1, where Q is obtained by the following expression:
$$Q = \frac{{τ}_{FWHM}}{2 {τ}_{C}} ,$$
where τ_{FWHM} is the pulse duration of the conditioned laser pulse, and τ_{c} is obtained by the following expression:
τ_{c}=\sqrt{ [symbol]t² [symbol] − [symbol] t [symbol] ²},
where [symbol]
t² [symbol] =∫_{-∞}^{+∞}t²I(t)dt and [symbol] t [symbol] =∫_{-∞}^{+∞}tI(t)dt,
where t is time (e.g., measured in seconds) and I(t) is laser pulse intensity as a function of time.

4. The apparatus of claim 1, wherein at least one of the pulse conditioner and the amplifier is further configured to at least quasi-linearly chirp the conditioned laser pulse.

5. The apparatus of claim 1, further comprising a pulse compressor configured to temporally compress the amplified laser pulse, thereby generating a compressed laser pulse.

6. The apparatus of claim 5, wherein a temporal intensity profile of the compressed laser pulse is characterized by a quality factor, Q, of greater than or equal to 0.2, where Q is obtained by the following expression:
$$Q = \frac{{τ}_{FWHM}}{2 {τ}_{C}} ,$$
where τ_{FWHM} is the pulse duration of the compressed laser pulse, and τ_{c} is obtained by the following expression:
τ_{c}=\sqrt{ [symbol]t² [symbol] − [symbol] t [symbol] ²},
where [symbol]
t² [symbol] =∫_{-∞}^{+∞}t²I(t)dt and [symbol] t [symbol] =∫_{-∞}^{+∞}tI(t)dt,
where t is time (e.g., measured in seconds) and I(t) is laser pulse intensity as a function of time.

7. The apparatus of claim 1, further comprising a parabolic pulse source, the parabolic pulse source comprising:
a seed laser configured to generate the input laser pulse having an input temporal intensity profile.

8. The apparatus of claim 7, wherein the input temporal intensity profile of the input laser pulse is a chosen one of a Gaussian profile, a sech2 profile, and a Lorentzian profile.

9. The apparatus of claim 1, wherein the conditioned laser pulse has a conditioned pulse duration greater than an input laser pulse duration of the input laser pulse.

10. The apparatus of claim 5, wherein a compressed pulse duration is in a range from 10 to 100 times less than a conditioned pulse duration.

11. The apparatus of claim 5, wherein a compressed pulse duration is in a range from 10 to 60 times less than an input laser pulse duration.

12. The apparatus of claim 5, wherein a compressed pulse duration is in a range from 0.1 ps to 10 ps.

13. The apparatus of claim 1, wherein the input laser pulse has an input spectral bandwidth in a range from 0.01 nm to 1 nm.

14. The apparatus of claim 1, wherein the conditioned laser pulse has a conditioned spectral bandwidth greater than an input spectral bandwidth of the input laser pulse.

15. The apparatus of claim 14, wherein the conditioned spectral bandwidth is in a range from 20 to 100 times the input spectral bandwidth.

16. The apparatus of claim 14, wherein the conditioned spectral bandwidth is in a range from 0.1 nm to 10 nm.

17. The apparatus of claim 1, wherein the input laser pulse has an input central wavelength greater than 260 nm.

18. The apparatus of claim 1, wherein the input laser pulse has an input pulse energy in a range from 10 pJ to 10 nJ.

19. The apparatus of claim 1, wherein the amplifier includes at least one of a fiber amplifier, a multi-pass amplifier, and a regenerative amplifier.

20. The apparatus of claim 1, wherein the amplifier includes:
a pre-amplifier stage configured to amplify the conditioned laser pulse, thereby creating a preliminary amplified laser pulse; and
a power amplifier stage configured to further amplify the preliminary amplified laser pulse, thereby creating the amplified laser pulse.

21. The apparatus of claim 1, wherein the peak power of the amplified laser pulse is in a range from 1 kW to 4 MW.

22. The apparatus of claim 5, wherein the peak power of the compressed laser pulse is in a range from 10 kW to 500 MW.

23. A method, comprising:
modifying a temporal intensity profile of an input laser pulse, thereby creating a conditioned laser pulse having conditioned temporal intensity profile characterized by a misfit parameter, M, of less than 0.13, where M is obtained by the following expression:
$${M}^{2} = \frac{\int {[ {\vert ψ \vert}^{2} - {\vert {ψ}_{Pfit} \vert}^{2} ]}^{2} d t}{\int {\vert ψ \vert}^{4} d t}$$
where |Ψ(t)|2 represents the pulse temporal intensity profile of the conditioned laser pulse and |ΨPfit(t)|2 represents a parabolic fit of the conditioned laser pulse; and
amplifying the conditioned laser pulse, thereby creating an amplified laser pulse.

24. A method, comprising:
modifying a temporal intensity profile of an input laser pulse having a pulse duration of at least 1 ps, thereby creating a conditioned laser pulse;
amplifying the conditioned laser pulse, thereby creating an amplified laser pulse; and
temporally compressing the amplified laser pulse, thereby generating a compressed laser pulse having a compressed pulse duration less than the input pulse duration.
